(19) United States
(12) Patent Application Publication
(10) Pub. No.: US 2025/0365077 A1
(43) Pub. Date: Nov. 27, 2025

(54) OPTICAL TRANSMITTER, OPTICAL RECEIVER, OPTICAL COMMUNICATION SYSTEM AND CONTROL SIGNAL SUPERIMPOSITION METHOD

(71) Applicant: NIPPON TELEGRAPH AND TELEPHONE CORPORATION, Tokyo (JP)

(72) Inventors: Takuya KANAI, Musashino-shi (JP); Yasunari TANAKA, Musashino-shi (JP); Kazutaka HARA, Musashino-shi (JP); Junichi KANI, Musashino-shi (JP)

(73) Assignee: NIPPON TELEGRAPH AND TELEPHONE CORPORATION, Tokyo (JP)

(21) Appl. No.: 18/874,925

(22) PCT Filed: Jun. 20, 2022
(86) PCT No.: PCT/JP2022/024503

§ 371 Date: Dec. 13, 2024

(51) Int. Cl. H04B 10/572; H04B 10/516; H04B 10/61

(52) U.S. Cl. CPC H04B 10/572; H04B 10/516; H04B 10/614

(57) ABSTRACT

An optical transmitter includes: a main signal generation unit that generates a main signal; a control signal generation unit that generates a control signal having a speed lower than a speed of the main signal; a wavelength-tunable driver that converts the control signal generated by the control signal generation unit into a signal for wavelength control; and a wavelength-tunable transmitter that generates a modulated optical signal on the basis of the main signal and the signal for wavelength control.

### TECHNICAL FIELD

The present invention relates to an optical transmitter, an optical receiver, an optical communication system, and a control signal superimposing method.

### BACKGROUND ART

As a method of simultaneously transmitting and receiving a main signal and a control signal in a single optical transmitter, there has conventionally been a method using a control signal called auxiliary management and control channel (AMCC). In the method using an AMCC signal, the AMCC signal is superimposed in a low-frequency region of a main signal, and thus the main signal and the AMCC signal can be simultaneously transmitted and received without affecting the main signal (see, for example, Non Patent Literature 1). Generally, the main signal has a modulation rate of, for example, 10 Gbit/s, whereas the AMCC signal has a modulation rate of several hundreds of kbps. A modulation method is an intensity modulation method, and there are two modulations: baseband modulation and modulation using a carrier signal.

According to Non Patent Literature 1, there are two types of methods of superimposing an AMCC signal. A first method “baseband modulation” is a method of superimposing an AMCC signal on a main signal as a baseband signal on a transmitter side. In the “baseband modulation” superimposing method, the AMCC signal is separated by a filter such as a low-pass filter (LPF) on a receiver side.

A second method “low-frequency pilot tone” is a method of up-converting an AMCC signal to a certain carrier frequency and superimposing the AMCC signal on a main signal on the transmitter side. In the “low-frequency pilot tone” superimposing method, the AMCC signal is acquired by performing demodulation by signal processing or the like on the receiver side. In both the superimposing methods, a ratio of amplitudes of the main signal and the AMCC signal is defined as a modulation index, and an appropriate value is set according to a system requirement.

### CITATION LIST

### Non Patent Literature

Non Patent Literature 1: ITU-T G.989.2 Amendment 1, “40-Gigabit-capable-passive optical networks 2 (NG-PON2): Physical media dependent (PMD) layer specification”, October 2020.

### SUMMARY OF INVENTION

### Technical Problem

The modulation index needs to be set to an appropriate value according to a value of a system budget required by a main signal and an AMCC signal in accordance with a system requirement. That is, it is necessary to set the modulation index such that both the main signal and the AMCC signal satisfy a desired budget. Mainly, the modulation index is adjusted by controlling a signal amplitude of the AMCC signal.

However, the intensity modulation method (e.g. on-off-keying (OOK) or phase shift keying (PSK)) is generally used for the AMCC signal, and thus the modulation index and a signal characteristic of the main signal have a trade-off relationship. Therefore, there is a problem that the signal characteristic of the main signal deteriorates in a case where the modulation index is increased to improve a signal characteristic (e.g. receiving sensitivity) of the AMCC signal. Note that the problem occurs not only in the AMCC signal, but also in control signals superimposed on a main signal and transmitted and received simultaneously with the main signal.

In view of the above circumstances, an object of the present invention is to provide a technique capable of superimposing a control signal without affecting an intensity of a main signal.

### Solution to Problem

An aspect of the present invention is an optical transmitter including: a main signal generation unit that generates a main signal; a control signal generation unit that generates a control signal having a speed lower than a speed of the main signal; a wavelength-tunable driver that converts the control signal generated by the control signal generation unit into a signal for wavelength control; and a wavelength-tunable transmitter that generates a modulated optical signal on the basis of the main signal and the signal for wavelength control.

An aspect of the present invention is a receiver including: a splitter that receives a modulated optical signal transmitted from an optical transmitter and splits the received modulated optical signal, the optical transmitter including a main signal generation unit that generates a main signal, a control signal generation unit that generates a control signal having a speed lower than a speed of the main signal, a wavelength-tunable driver that converts the control signal generated by the control signal generation unit into a signal for wavelength control, and a wavelength-tunable transmitter that generates the modulated optical signal on the basis of the main signal and the signal for wavelength control; a main signal reception unit that acquires the main signal on the basis of the modulated optical signal split by the splitter; and a reception wavelength identification unit that converts the modulated optical signal split by the splitter into an electric signal and acquires wavelength information indicating the control signal from the electric signal.

An aspect of the present invention is an optical communication system including an optical transmitter, an optical receiver, and a photonic gateway that relays communication between the optical transmitter and the optical receiver, in which: the optical transmitter includes a main signal generation unit that generates a main signal, a control signal generation unit that generates a control signal having a speed lower than a speed of the main signal, a wavelength-tunable driver that converts the control signal generated by the control signal generation unit into a signal for wavelength control, and a wavelength-tunable transmitter that generates a modulated optical signal on the basis of the main signal and the signal for wavelength control and transmits the generated modulated optical signal to the optical receiver via the photonic gateway; and the optical receiver includes a separation unit that receives the modulated optical signal via the photonic gateway and demultiplexes or splits the received modulated optical signal, and a control signal processing unit that acquires the control signal on the basis of the demultiplexed or split modulated optical signal.

An aspect of the present invention is a control signal superimposing method including: generating a main signal; generating a control signal having a speed lower than a speed of the main signal; converting the generated control signal into a signal for wavelength control; and generating a modulated optical signal on the basis of the main signal and the signal for wavelength control.

### Advantageous Effects of Invention

According to the present invention, it is possible to superimpose a control signal without affecting an intensity of a main signal.

### BRIEF DESCRIPTION OF DRAWINGS

FIG. 1 A configuration example of an optical communication system according to a first embodiment.

FIG. 2 A sequence diagram showing a flow of processing of the optical communication system according to the first embodiment.

FIG. 3 An explanatory diagram regarding a wavelength-tunable light source according to a second embodiment.

FIG. 4 A relationship between a DBR current and an oscillation wavelength of the wavelength-tunable light source according to the second embodiment.

FIG. 5 An explanatory diagram regarding a wavelength-tunable light source according to a third embodiment.

FIG. 6 A relationship between a phase current and an oscillation wavelength of the wavelength-tunable light source according to the third embodiment.

FIG. 7 A configuration example of an optical receiver according to a fourth embodiment.

FIG. 8 A configuration example of an optical receiver according to a fifth embodiment.

FIG. 9 A characteristic of an optical filter according to the fifth embodiment.

FIG. 10 A configuration example of an optical communication system according to a sixth embodiment.

### DESCRIPTION OF EMBODIMENTS

Hereinafter, embodiments of the present invention will be described with reference to drawings.

### First Embodiment

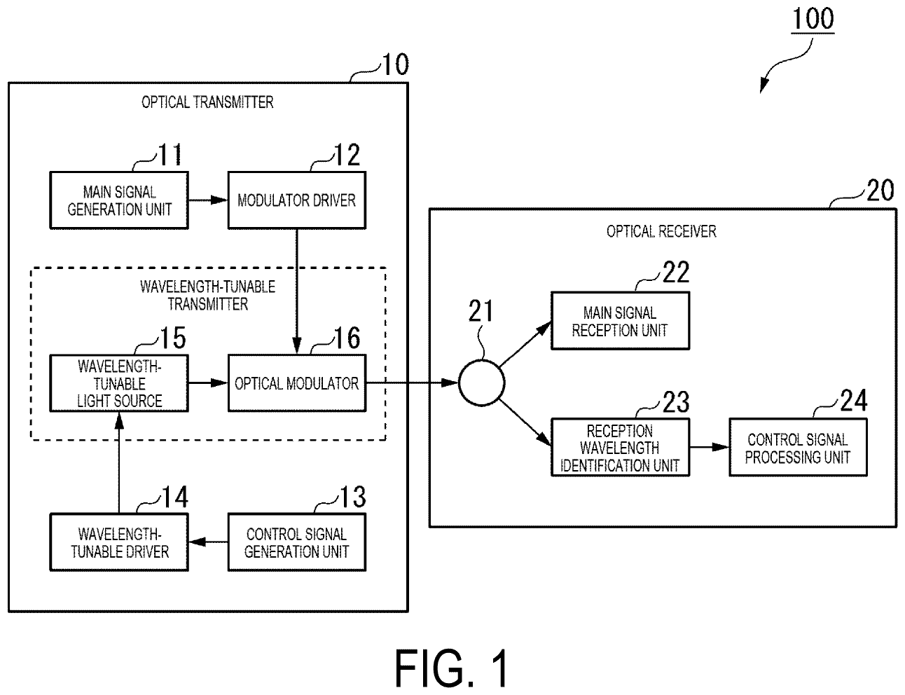

FIG. 1 shows a configuration example of an optical communication system 100 according to a first embodiment. The optical communication system 100 includes one or more optical transmitters 10 and one or more optical receivers 20. FIG. 1 shows one optical transmitter 10 and one optical receiver 20. The optical transmitter 10 and the optical receiver 20 are connected via an optical transmission line. The optical transmission line is, for example, an optical fiber.

The optical transmitter 10 includes a main signal generation unit 11, a modulator driver 12, a control signal generation unit 13, a wavelength-tunable driver 14, a wavelength-tunable light source 15, and an optical modulator 16. The wavelength-tunable light source 15 and the optical modulator 16 are configured as a wavelength-tunable transmitter.

The main signal generation unit 11 generates a main signal (e.g. binary data).

The modulator driver 12 converts the main signal generated by the main signal generation unit 11 into a signal to be used for modulation by the optical modulator 16 (e.g. non-return-to-zero (NRZ) electric signal).

The control signal generation unit 13 generates a control signal. The control signal is, for example, an AMCC signal. The AMCC signal is a signal used for management and control.

The wavelength-tunable driver 14 converts the control signal generated by the control signal generation unit 13 into a signal for wavelength control (e.g. NRZ electric signal). Here, the signal for wavelength control differs depending on a wavelength-tunable laser used as the wavelength-tunable light source 15. For example, in a case where a wavelength linearly changes with respect to the signal for wavelength control (e.g. voltage), a modulation signal such as a main signal can be applied. Meanwhile, in a case where the wavelength intermittently changes with respect to the signal for wavelength control as in a distributed Bragg reflector (DBR)-LD, it is necessary to set a control signal according to a characteristic thereof. The wavelength-tunable driver 14 is a device used to limit an oscillation wavelength of the wavelength-tunable light source 15.

In a case where the control signal is a binary bit string, the wavelength-tunable driver 14 allocates a mark (“1”) to a wavelength (e.g. λ₁) having a lower transmission line loss and allocates a space (“0”) to a wavelength (e.g. λ₂) having a larger transmission loss. This makes it possible to suppress deterioration of a signal-to-noise ratio of the mark and to improve a sensitivity (increase a transmission distance).

The wavelength-tunable light source 15 changes the oscillation wavelength in response to the signal for wavelength control converted by the wavelength-tunable driver 14. The wavelength-tunable light source 15 outputs light having a wavelength corresponding to the oscillation wavelength.

When the control signal is allocated to the wavelength as described above, the wavelength-tunable light source 15 can place the control signal on an optical signal as wavelength information. The wavelength-tunable light source 15 is, for example, a wavelength sweep light source capable of externally controlling the oscillation wavelength. Note that the wavelength-tunable light source 15 may also be a wavelength-tunable semiconductor laser (e.g. DBR laser, distributed-feed back (DFB) laser, tunable distributed amplification-DFB (TDA-DFB) laser, or external resonator laser).

The optical modulator 16 modulates the light output from the wavelength-tunable light source 15 with the signal (corresponding to the main signal) output from the modulator driver 12. Thus, the optical modulator 16 generates a modulated optical signal.

The optical receiver 20 includes a splitter 21, a main signal reception unit 22, a reception wavelength identification unit 23, and a control signal processing unit 24.

The splitter 21 splits the modulated optical signal transmitted from the optical transmitter 10. The modulated optical signals split by the splitter 21 are output to the main signal reception unit 22 and the reception wavelength identification unit 23.

The main signal reception unit 22 acquires the main signal on the basis of the modulated optical signal split by the splitter 21. For example, the main signal reception unit 22 converts the modulated optical signal into an electric signal and acquires the main signal from the electric signal.

The reception wavelength identification unit 23 converts the modulated optical signal split by the splitter 21 into an electric signal. The reception wavelength identification unit 23 acquires the wavelength information from the electric signal. For example, the reception wavelength identification unit 23 acquires the wavelength information by monitoring the electric signal. The wavelength information acquired by the reception wavelength identification unit 23 is information indicating the control signal. For example, as described above, in a case where the control signal is a binary bit string, the mark (“1”) is allocated to a wavelength (e.g. λ₁) having a lower transmission line loss, and the space (“0”) is allocated to a wavelength (e.g. λ₂) having a larger transmission loss. Thus, the reception wavelength identification unit 23 can acquire the wavelength information on the basis of the electric signal. The reception wavelength identification unit 23 is, for example, a device capable of acquiring the wavelength information, such as an optical spectrum analyzer. Therefore, the reception wavelength identification unit 23 is not limited to the optical spectrum analyzer, and a wavelength multiplexer/demultiplexer including a diffraction grating or the like may be used.

The control signal processing unit 24 receives the wavelength information acquired by the reception wavelength identification unit 23 as input. The control signal processing unit 24 acquires the control signal on the basis of the input wavelength information. For example, the control signal processing unit 24 acquires the control signal from the wavelength indicated by the wavelength information. Information regarding the wavelength to which the control signal is allocated is issued in advance from the optical transmitter 10.

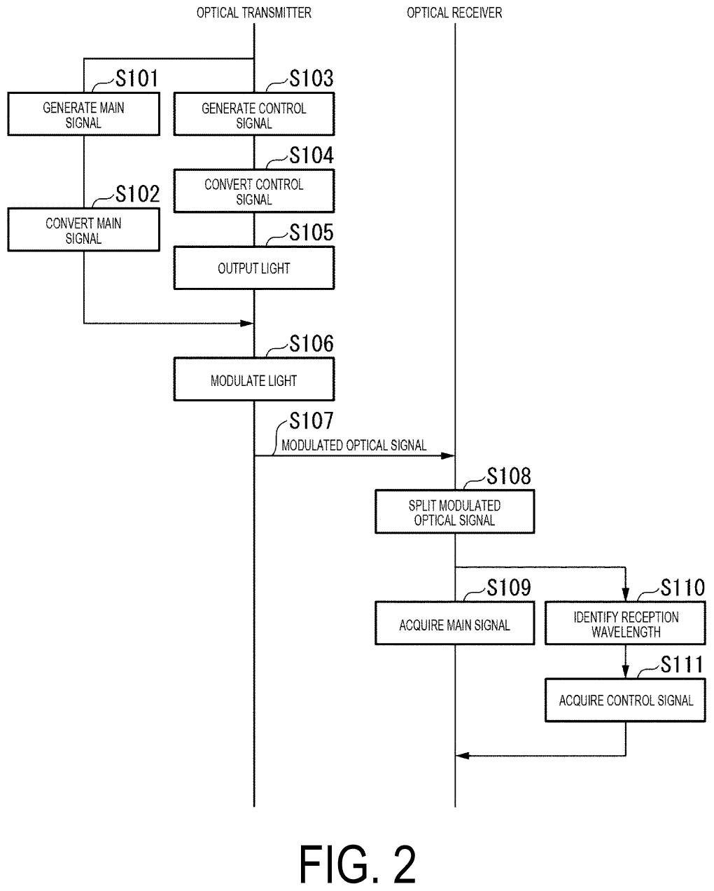

FIG. 2 is a sequence diagram showing a flow of processing of the optical communication system 100 according to the first embodiment.

The main signal generation unit 11 of the optical transmitter 10 generates a main signal (step S101). The main signal generation unit 11 outputs the generated main signal to the modulator driver 12. The modulator driver 12 converts the main signal generated by the main signal generation unit 11 into a signal to be used for modulation by the optical modulator 16 (step S102). The modulator driver 12 outputs the converted signal to the optical modulator 16.

The control signal generation unit 13 generates a control signal (step S103). The control signal generation unit 13 outputs the generated control signal to the wavelength-tunable driver 14. The wavelength-tunable driver 14 converts the control signal output from the control signal generation unit 13 into a signal for wavelength control (step S104). The wavelength-tunable driver 14 outputs the signal for wavelength control to the wavelength-tunable light source 15. The wavelength-tunable light source 15 outputs light having a wavelength corresponding to the signal for wavelength control output from the wavelength-tunable driver 14 (step S105).

The light output from the wavelength-tunable light source 15 is input to the optical modulator 16. The optical modulator 16 modulates the light output from the wavelength-tunable light source 15 with the changed signal output from the modulator driver 12 (step S106). Thus, the optical modulator 16 generates a modulated optical signal. The optical modulator 16 outputs the generated modulated optical signal to the optical transmission line (step S107). The modulated optical signal output from the optical transmitter 10 is input to the optical receiver 20.

The splitter 21 of the optical receiver 20 splits the input modulated optical signal (step S108). The modulated optical signals split by the splitter 21 are input to the main signal reception unit 22 and the reception wavelength identification unit 23. The main signal reception unit 22 acquires the main signal from the input modulated optical signal (step S109). The reception wavelength identification unit 23 converts the input modulated optical signal into an electric signal and acquires wavelength information from the electric signal (step S110). The reception wavelength identification unit 23 outputs the acquired wavelength information to the control signal processing unit 24. The control signal processing unit 24 acquires the control signal on the basis of the wavelength information (step S111).

According to the optical communication system 100 configured as described above, the main signal and the control signal are individually modulated in the optical transmitter 10. Specifically, the main signal is modulated by the optical modulator 16, and the control signal is modulated as the oscillation wavelength of the wavelength-tunable light source 15. As described above, the oscillation wavelength is changed in the wavelength-tunable light source 15 in response to an input signal. For example, in a case where the control signal is a binary bit string, the mark is allocated to a wavelength having a lower transmission line loss, and the space is allocated to a wavelength having a larger transmission loss, which makes it possible to suppress deterioration of the signal-to-noise ratio of the mark and to further increase the sensitivity. As described above, when the control signal is transmitted and received as the wavelength information, it is possible to superimpose the control signal on the main signal without affecting the intensity of the main signal.

### First Modification Example of First Embodiment

The above embodiment shows a configuration in which light output from the wavelength-tunable light source 15 in the wavelength-tunable transmitter included in the optical transmitter 10 is modulated by the optical modulator 16 to generate a modulated optical signal. Meanwhile, the wavelength-tunable transmitter included in the optical transmitter 10 may directly perform modulation to generate a modulated optical signal. In such a configuration, the optical transmitter 10 generates a modulated optical signal by inputting a signal output from the modulator driver 12 to the wavelength-tunable light source 15.

### Second Embodiment

In a second embodiment, a configuration using a DBR laser as a wavelength-tunable light source of an optical transmitter will be described.

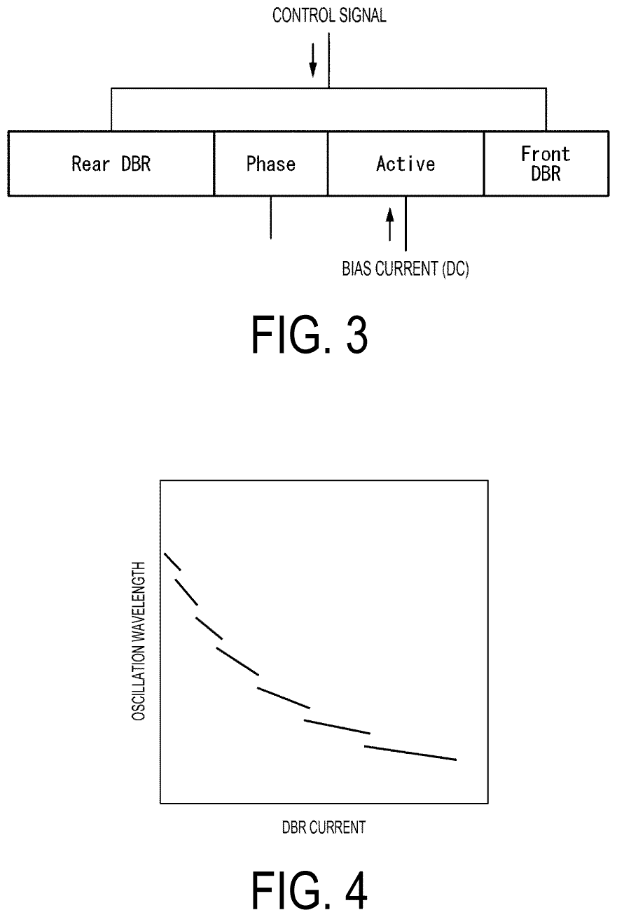

FIG. 3 is an explanatory diagram regarding the wavelength-tunable light source 15 according to the second embodiment. As shown in FIG. 3, the wavelength-tunable light source 15 includes a front DBR region (“Front DBR” in FIG. 3), an active region (“Active” in FIG. 3), a phase region (“Phase” in FIG. 3), and a rear DBR region (“Rear DBR” in FIG. 3). In the second embodiment, the wavelength-tunable driver 14 controls a wavelength by controlling a current to be input to the front DBR region and the rear DBR region included in the wavelength-tunable light source 15.

FIG. 4 shows a relationship between a DBR current and an oscillation wavelength of the wavelength-tunable light source 15 according to the second embodiment. As shown in FIG. 4, the oscillation wavelength can be controlled by adjusting the DBR current indicating the current to be input to the DBR regions. Therefore, the wavelength-tunable driver 14 according to the second embodiment can transmit and receive a control signal as wavelength information by setting an arbitrary wavelength in a range of the oscillation wavelengths in FIG. 4 as a wavelength to which the control signal is allocated.

### First Modification Example of Second Embodiment

The above embodiment shows an example of using the DBR laser as the wavelength-tunable light source 15, but a super structure grating-DBR (SSG-DBR) laser, a sampled grating-DBR (SG-DBR) laser, or a tunable distributed amplification (TDA)-DFB laser may be used. A method of selecting a wavelength by controlling a chip temperature by using a DFB laser as the wavelength-tunable light source 15 may be used.

### Third Embodiment

In a third embodiment, a configuration using a DBR laser as a wavelength-tunable light source of an optical transmitter will be described.

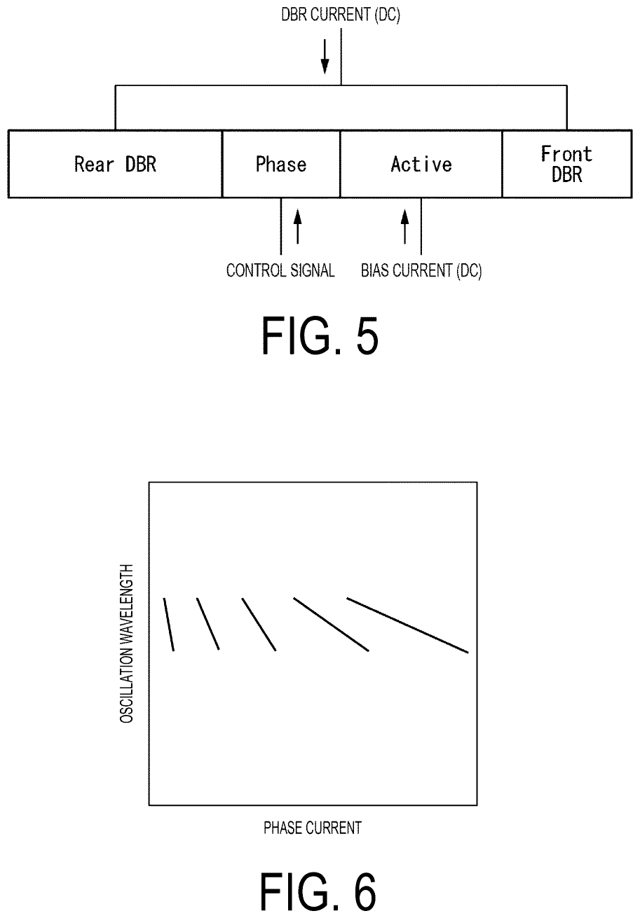

FIG. 5 is an explanatory diagram regarding the wavelength-tunable light source 15 according to the third embodiment. As shown in FIG. 5, the wavelength-tunable light source 15 includes a front DBR region (“Front DBR” in FIG. 5), an active region (“Active” in FIG. 5), a phase region (“Phase” in FIG. 5), and a rear DBR region (“Rear DBR” in FIG. 5). In the third embodiment, the wavelength-tunable driver 14 controls a wavelength by controlling a current to be input to the phase region included in the wavelength-tunable light source 15.

FIG. 6 shows a relationship between a phase current and an oscillation wavelength of the wavelength-tunable light source 15 according to the third embodiment. Here, the phase current indicates the current to be input to the phase region. As shown in FIG. 6, the oscillation wavelength can be controlled by adjusting the phase current indicating the current to be input to the phase region. Therefore, the wavelength-tunable driver 14 according to the third embodiment can transmit and receive a control signal as wavelength information by setting an arbitrary wavelength in a range of the oscillation wavelengths in FIG. 6 as a wavelength to which the control signal is allocated.

### First Modification Example of Third Embodiment

The above embodiment shows an example of using the DBR laser as the wavelength-tunable light source 15, but a super structure grating-DBR (SSG-DBR) laser or a sampled grating-DBR (SG-DBR) laser may be used. A method of selecting a wavelength by controlling a chip temperature by using a DFB laser as the wavelength-tunable light source 15 may be used.

### Fourth Embodiment

In a fourth embodiment, an optical communication system including the optical transmitter according to any one of the first to third embodiments and an optical receiver different from the optical receivers according to the first to third embodiments will be described.

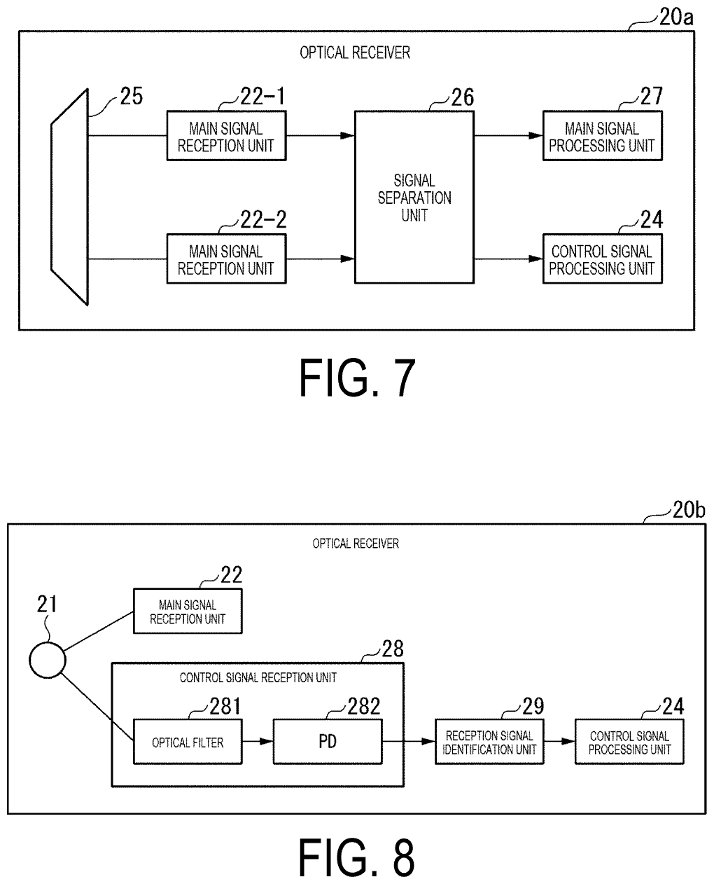

The optical communication system including the optical transmitter according to any one of the first to third embodiments includes an optical receiver 20a as the optical receiver different from the optical receivers according to the first to third embodiments. FIG. 7 shows a configuration example of the optical receiver 20a according to the fourth embodiment. The optical receiver 20a includes main signal reception units 22-1 and 22-2, the control signal processing unit 24, an optical multiplexer/demultiplexer 25, a signal separation unit 26, and a main signal processing unit 27.

The optical multiplexer/demultiplexer 25 demultiplexes a modulated optical signal transmitted from the optical transmitter 10. The optical multiplexer/demultiplexer 25 includes a plurality of ports that outputs optical signals having different wavelengths, and each port is connected to the main signal reception unit 22. For example, the main signal reception unit 22-1 is connected to the port that outputs an optical signal having the wavelength λ₁, and the main signal reception unit 22-2 is connected to the port that outputs an optical signal having the wavelength λ₂. The modulated optical signals demultiplexed by the optical multiplexer/demultiplexer 25 are input to the main signal reception units 22-1 and 22-2. For example, the modulated optical signal having the wavelength λ₁ is input to the main signal reception unit 22-1, and the modulated optical signal having the wavelength λ₂ is input to the main signal reception unit 22-2.

The main signal reception units 22-1 and 22-2 receive the modulated optical signals having different wavelengths demultiplexed by the optical multiplexer/demultiplexer 25. When receiving the modulated optical signals output from the optical multiplexer/demultiplexer 25, the main signal reception units 22-1 and 22-2 each output the received modulated optical signal to the signal separation unit 26. The modulated optical signals to be output to the signal separation unit 26 have different wavelengths.

Based on the modulated optical signal output from at least one of the main signal reception units 22-1 and 22-2, the signal separation unit 26 determines which one of the main signal reception units 22 has received the modulated optical signal. That is, the signal separation unit 26 determines which one of the main signal reception units 22-1 and 22-2 has received the modulated optical signal. The signal separation unit 26 determines a wavelength allocated to a control signal on the basis of the main signal reception unit 22 that has received the modulated optical signal. The signal separation unit 26 outputs the modulated optical signal to the main signal processing unit 27 and outputs a determination result and the modulated optical signal to the control signal processing unit 24. The determination result includes information regarding the wavelength allocated to the control signal.

The control signal processing unit 24 receives the determination result and the modulated optical signal output from the signal separation unit 26 as input. The control signal processing unit 24 acquires the control signal on the basis of wavelength information indicated by the input determination result and the modulated optical signal.

The main signal processing unit 27 converts the modulated optical signal output from the signal separation unit 26 into an electric signal and acquires a main signal from the electric signal.

In the optical communication system 100 according to the fourth embodiment configured as described above, the modulated optical signal is demultiplexed for each wavelength in the optical multiplexer/demultiplexer 25 of the optical receiver 20a. The modulated optical signal output from the port corresponding to the wavelength of the modulated optical signal is received by any one of the main signal reception units 22. The signal separation unit 26 of the optical receiver 20a determines the wavelength of the control signal on the basis of the main signal reception unit 22 that has output the modulated optical signal and notifies the control signal processing unit 24 of the determination result. This makes it possible to separately acquire the main signal and the control signal.

### Fifth Embodiment

In a fifth embodiment, an optical communication system including the optical transmitter according to any one of the first to third embodiments and an optical receiver different from the optical receivers according to the first to third embodiments will be described.

The optical communication system including the optical transmitter according to any one of the first to third embodiments includes an optical receiver 20b as the optical receiver different from the optical receivers according to the first to third embodiments. FIG. 8 shows a configuration example of the optical receiver 20b according to the fifth embodiment. The optical receiver 20b includes the splitter 21, the main signal reception unit 22, the control signal processing unit 24, a control signal reception unit 28, and a reception signal identification unit 29.

The splitter 21 splits a modulated optical signal transmitted from the optical transmitter 10. The modulated optical signals split by the splitter 21 are input to the main signal reception unit 22 and the control signal reception unit 28.

The main signal reception unit 22 converts the modulated optical signal split by the splitter 21 into an electric signal and acquires a main signal from the electric signal.

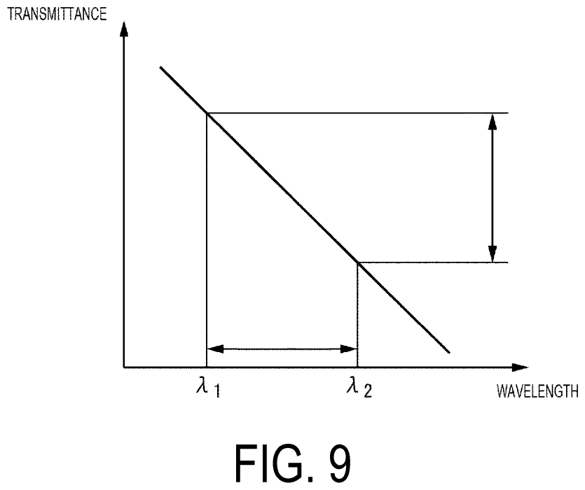

The control signal reception unit 28 includes an optical filter 281 and a PD 282. The optical filter 281 is an optical filter having a characteristic shown in FIG. 9. Examples of the optical filter 281 include a multilayer filter and an etalon filter. The optical filter 281 may be an optical filter including an optical interferometer, such as a Mach-Zehnder filter.

FIG. 9 shows the characteristic of the optical filter 281 according to the fifth embodiment. As shown in FIG. 9, the optical filter 281 has a characteristic in which transmittance differs for each wavelength. At this time, in a case where the wavelengths λ₁ and λ₂ are allocated as a control signal in the optical transmitter 10, the modulated optical signal transmitted through the optical filter 281 has a different intensity for each wavelength. Therefore, the modulated optical signal is converted into an intensity-modulated optical signal.

The PD 282 receives the modulated optical signal transmitted through the optical filter 281. The PD 282 converts the received modulated optical signal into an electric signal. As described above, the PD 282 receives the modulated optical signal transmitted through the optical filter 281 and thus can handle the modulated optical signal as a normal OOK signal (e.g. NRZ). The electric signal converted by the PD 282 is output to the reception signal identification unit 29.

The reception signal identification unit 29 identifies the electric signal output from the PD 282. Specifically, the reception signal identification unit 29 acquires a voltage value of the electric signal. For example, a trans impedance amplifier (TIA) is provided between the PD 282 and the reception signal identification unit 29, and the TIA converts the electric signal output from the PD 282 into a voltage signal. The reception signal identification unit 29 acquires the voltage value on the basis of the voltage signal output from the TIA.

The control signal processing unit 24 receives an identification result identified by the reception signal identification unit 29 and the electric signal as input. The control signal processing unit 24 acquires the control signal on the basis of the input identification result and electric signal.

In the optical communication system 100 according to the fifth embodiment configured as described above, the modulated optical signal is split in the splitter 21 of the optical receiver 20b. The split modulated optical signal is converted into an intensity-modulated signal by the optical filter 281. The reception signal identification unit 29 of the optical receiver 20b identifies the intensity-modulated signal and notifies the control signal processing unit 24 of the identification result. This makes it possible to separately acquire the main signal and the control signal.

### Sixth Embodiment

In a sixth embodiment, a configuration in which the optical transmitter according to any one of the first to third embodiments and the optical receiver according to any one of the first to fifth embodiments are applied to a subscriber device and a photonic gateway of an all-photonics network will be described.

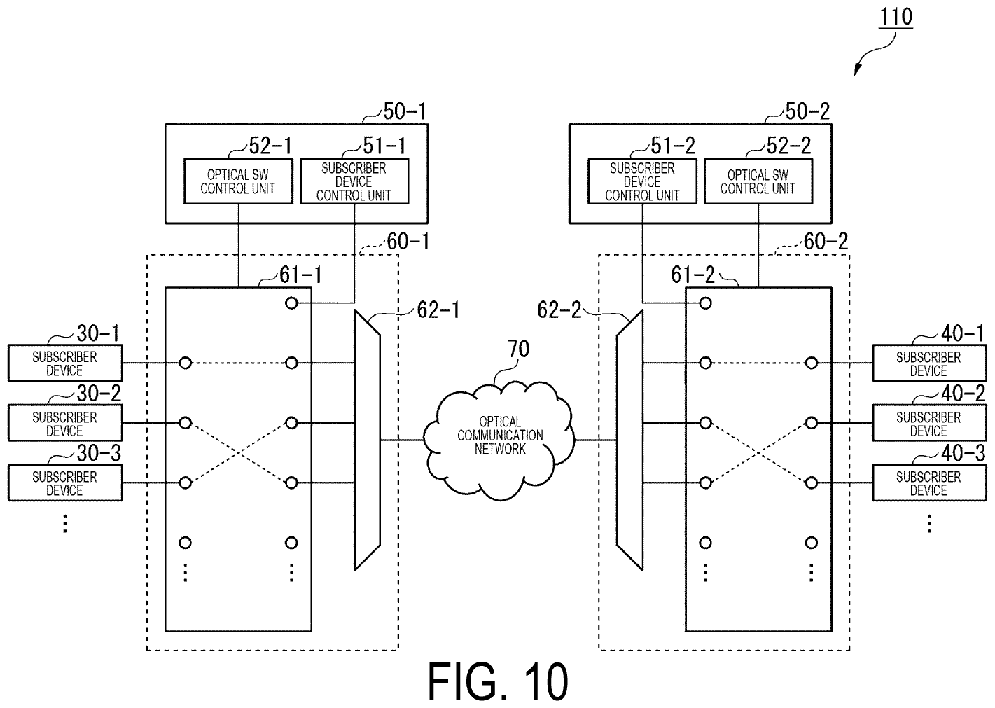

FIG. 10 shows a configuration example of an optical communication system 110 according to a sixth embodiment. The optical communication system 110 includes a plurality of subscriber devices 30 (e.g. subscriber devices 30-1 to 30-3), a plurality of subscriber devices 40 (e.g. subscriber devices 40-1 to 40-3), a plurality of control units 50 (e.g. control units 50-1 to 50-2), and a plurality of photonic gateways 60 (e.g. photonic gateways 60-1 to 60-2).

The subscriber devices 30 and the photonic gateway 60-1, the photonic gateway 60-1 and the photonic gateway 60-2, and the photonic gateway 60-2 and the subscriber devices 40 are connected by using optical transmission lines. The photonic gateway 60-1 and the photonic gateway 60-2 are connected by an optical communication network 70. In the following description, the subscriber devices 30 will be referred to as a transmission side, and the subscriber devices 40 will be referred to as a reception side.

The subscriber device 30 includes the optical transmitter 10 according to any one of the first to third embodiments. The subscriber device 30 uses the optical transmitter 10 to transmit an optical signal. The subscriber device 30 is, for example, an optical network unit (ONU) installed in a subscriber's house.

The subscriber device 40 performs communication with the subscriber device 30. The subscriber device 40 includes the optical receiver 20, 20a, or 20b according to any one of the first to fifth embodiments. The subscriber device 40 uses the optical receiver 20, 20a, or 20b to receive an optical signal. The subscriber device 40 is, for example, an ONU installed in a subscriber's house.

The photonic gateway 60-1 includes an optical SW 61-1 and a wavelength multiplexer/demultiplexer unit 62-1. The photonic gateway 60-2 includes an optical SW 61-2 and a wavelength multiplexer/demultiplexer unit 62-2. The photonic gateway 60-1 and the photonic gateway 60-2 perform similar processing, and thus the optical SW 61 and the wavelength multiplexer/demultiplexer unit 62 will be described without distinguishing the photonic gateways 60.

The optical SW 61 includes M (M is an integer of 2 or more) first ports and N (N is an integer of 2 or more) second ports. An optical signal input to a certain port of the optical SW 61 is output from another port. For example, an optical signal input to the first port of the optical SW 61 is output from the second port.

In the example of FIG. 10, the subscriber devices 30 are connected to the first ports of the optical SW 61-1 via optical transmission lines, and the photonic gateway 60-2 is connected to the second ports of the optical SW 61-1 via optical transmission lines. In the example of FIG. 10, the subscriber devices 40 are connected to the first ports of the optical SW 61-2 via optical transmission lines, and the photonic gateway 60-1 is connected to the second ports of the optical SW 61-2 via optical transmission lines.

The wavelength multiplexer/demultiplexer unit 62 multiplexes or demultiplexes an input optical signal.

The control units 50 perform at least control of the subscriber devices 30 and 40 and control of the respective photonic gateways 60. Here, the control of the subscriber devices 30 and 40 is, for example, allocation of light emission wavelengths to the subscriber devices 30 and 40, a light stop instruction, or a wavelength change instruction. The control of the photonic gateway 60 is, for example, switching of connection between the ports of the optical SW 61 included in the photonic gateway 60 or setting of an optical path.

Each control unit 50 controls the corresponding photonic gateway 60 and the subscriber devices 30 or 40 connected to the photonic gateway 60. For example, the control unit 50-1 controls the photonic gateway 60-1 and the subscriber devices 30 connected to the photonic gateway 60-1. For example, the control unit 50-2 controls the photonic gateway 60-2 and the subscriber devices 40 connected to the photonic gateway 60-2.

The control unit 50-1 includes a subscriber device control unit 51-1 and an optical SW control unit 52-1. The control unit 50-2 includes a subscriber device control unit 51-2 and an optical SW control unit 52-2. The control unit 50-1 and the control unit 50-2 perform similar processing except that targets to be controlled are different, and thus the subscriber device control unit 51 and the optical SW control unit 52 will be described without distinguishing the control units 50.

In a case where a subscriber device is newly connected to the photonic gateway 60, the subscriber device control unit 51 specifies to which port of the optical SW included in the photonic gateway 60 the subscriber device newly connected to the photonic gateway 60 is connected and performs processing of opening an optical path such as a wavelength instruction to the subscriber device. Note that the processing of opening the optical path in the subscriber device control unit 51 is similar to that in conventional cases, and thus description thereof is omitted.

The optical SW control unit 52 sets and switches connection between the ports of the optical SW included in the photonic gateway 60 and sets the optical path. As shown in FIG. 10, in a case where an optical path that communicably connects the subscriber device 30-1 connected to the photonic gateway 60-1 and the subscriber device 40-1 connected to the photonic gateway 60-2 is opened, the control unit 50 allocates a wavelength to an End-End optical path such that a transmission wavelength (λm) of the subscriber device 30-1 serves as a reception wavelength of the subscriber device 40-1 and a transmission wavelength (An) of the subscriber device 40-1 serves as a reception wavelength of the subscriber device 30-1. Functions of the optical SW control unit 52 and the subscriber device control unit 51 may be implemented by one or more processors executing a program.

According to the optical communication system 110 configured as described above, the present invention can also be applied to the all-photonics network.

### First Modification Example of Sixth Embodiment

In the above embodiment, a configuration of one-way communication has been described as an example. Therefore, the subscriber devices 30 and 40 include either the optical transmitter 10 or the optical receiver 20, 20a, or 20b. Meanwhile, two-way communication is generally performed in the optical communication system 110. Therefore, the subscriber devices 30 and 40 included in the optical communication system 110 may have both the functions of the optical transmitter 10 and the optical receiver 20. In this case, the functions of the optical transmitter 10 and the optical receiver 20 included in the subscriber devices 30 and 40 may be combined in any way. For example, the subscriber devices 30 and 40 include a combination of the optical transmitter 10 according to any one of the first to third embodiments and the optical receiver 20, 20a, or 20b according to any one of the first to fifth embodiments.

### Second Modification Example of Sixth Embodiment

The photonic gateway 60 may include the optical transmitter according to any one of the first to third embodiments and the optical receiver according to any one of the first to fifth embodiments in order to exchange control signals with the subscriber devices 30 and 40. In this case, the subscriber devices 30 and 40 include a combination of the optical transmitter 10 according to any one of the first to third embodiments and the optical receiver 20, 20a, or 20b according to any one of the first to fifth embodiments.

Some or all of the functional units of the optical transmitter 10 or the optical receivers 20, 20a, and 20b are implemented as software by causing a processor such as a central processing unit (CPU) to execute a program stored in a storage device including a nonvolatile recording medium (non-transitory recording medium) and a storage unit. The program may be recorded in a computer-readable non-transitory recording medium. The computer-readable non-transitory recording medium is a non-transitory recording medium such as a portable medium including, for example, a flexible disk, a magneto-optical disk, a read only memory (ROM), and a compact disc read only memory (CD-ROM) or a storage device such as a hard disk built in a computer system.

Some or all of the functional units of the optical transmitter 10 or the optical receivers 20, 20a, and 20b may be implemented by using hardware including an electronic circuit (or circuitry) including, for example, a large scale integrated circuit (LSI), an application specific integrated circuit (ASIC), a programmable logic device (PLD), or a field programmable gate array (FPGA).

Although the embodiments of the present invention have been described in detail with reference to the drawings, specific configurations are not limited to the embodiments and include design and the like within the gist of the present invention.

### INDUSTRIAL APPLICABILITY

The present invention can be applied to an optical communication system that superimposes a control signal such as an AMCC on a main signal and transmits and receives the signal.

### REFERENCE SIGNS LIST

10 Optical transmitter
11 Main signal generation unit
12 Modulator driver
13 Control signal generation unit
14 Wavelength-tunable driver
15 Wavelength-tunable light source
16 Optical modulator
20, 20a, 20b Optical receiver
21 Splitter
22, 22-1 to 22-2 Main signal reception unit
23 Reception wavelength identification unit
24 Control signal processing unit
25 Optical multiplexer/demultiplexer
26 Signal separation unit
27 Main signal processing unit
28 Control signal reception unit
29 Reception signal identification unit
30, 40 Subscriber device
50 Control unit
51 Subscriber device control unit
52 Optical SW control unit
60 Photonic gateway
61 Optical SW
62 Wavelength multiplexer/demultiplexer unit
100, 110 Optical communication system
281 Optical filter
282 PD

1. An optical transmitter comprising:
a main signal generator configured to generate a main signal;
a control signal generator configured to generate a control signal having a speed lower than a speed of the main signal;
a wavelength-tunable driver configured to convert the control signal generated by the control signal generator into a signal for wavelength control; and
a wavelength-tunable transmitter configured to generate a modulated optical signal on the basis of the main signal and the signal for wavelength control.

2. The optical transmitter according to claim 1, wherein:
the wavelength-tunable transmitter includes an optical modulator and a wavelength-tunable light source;
the wavelength-tunable light source outputs light having a wavelength corresponding to the signal for wavelength control; and
the optical modulator generates the modulated optical signal by modulating the light output from the wavelength-tunable light source on the basis of the main signal.

3. The optical transmitter according to claim 2, wherein:
the wavelength-tunable light source is any one of a distributed Bragg reflector (DBR) laser, a super structure grating-DBR (SSG-DBR) laser, and a sampled grating-DBR (SG-DBR) laser capable of controlling a wavelength corresponding to an input current or a distributed-feedback (DFB) laser capable of controlling a wavelength by controlling a chip temperature; and
the wavelength-tunable driver inputs the signal for wavelength control to the wavelength-tunable light source to allocate an arbitrary wavelength in a range of oscillation wavelengths of the wavelength-tunable light source to the signal for wavelength control.

4. (canceled)

5. An optical communication system including an optical transmitter, an optical receiver, and a photonic gateway configured to relay communication between the optical transmitter and the optical receiver, wherein:
the optical transmitter includes
a main signal generator configured to generate a main signal,
a control signal generator configured to generate a control signal having a speed lower than a speed of the main signal,
a wavelength-tunable driver configured to convert the control signal generated by the control signal generator into a signal for wavelength control, and
a wavelength-tunable transmitter configured to generate a modulated optical signal on the basis of the main signal and the signal for wavelength control and transmits the generated modulated optical signal to the optical receiver via the photonic gateway; and
the optical receiver includes
a separator configured to receive the modulated optical signal via the photonic gateway and demultiplexes or splits the received modulated optical signal, and
a control signal processor configured to acquire the control signal on the basis of the demultiplexed or split modulated optical signal.

6. The optical communication system according to claim 5, wherein:
the optical receiver further includes
a plurality of main signal receivers configured to receive the modulated optical signals having different wavelengths demultiplexed by the separator, and
a signal separator configured to determine which one of the plurality of main signal receivers has received the modulated optical signal and determines that a wavelength corresponding to the main signal receiver that has received the modulated optical signal is allocated to the control signal; and
the control signal processor acquires the control signal on the basis of a result determined by the signal separator and the modulated optical signal.

7. The optical communication system according to claim 5, wherein:
the optical receiver further includes
an optical filter that has a characteristic in which transmittance differs for each wavelength and converts the modulated optical signal split by the separator into an intensity-modulated signal,
a photodiode configured to convert the intensity-modulated signal transmitted through the optical filter into an electric signal, and
a reception signal identifier configured to identify the electric signal output from the photodiode; and
the control signal processor acquires the control signal on the basis of a result identified by the reception signal identifier.

8. A control signal superimposing method comprising:
generating a main signal;
generating a control signal having a speed lower than a speed of the main signal;
converting the generated control signal into a signal for wavelength control; and
generating a modulated optical signal on the basis of the main signal and the signal for wavelength control.
